(19) United States
(12) Patent Application Publication
(10) Pub. No.: US 2026/0181320 A1
(43) Pub. Date: Jun. 25, 2026

(54) ACOUSTIC TRACKING SYSTEM

(71) Applicant: 9374-0587 QUEBEC INC., Sherbrooke (CA)

(72) Inventors: Philippe-Olivier PROVOST, Sherbrooke (CA); Jean-Samuel LAUZON, Saint-Anne de La Rochelle (CA); Jonathan VINCENT, Drummondville (CA); François GRONDIN, St-Mathieu de Beloeil (CA); François MICHAUD, Sherbrooke (CA)

(21) Appl. No.: 18/992,611

(22) PCT Filed: Jul. 13, 2023
(86) PCT No.: PCT/CA2023/050938

§ 371 Date: Jan. 9, 2025

Related U.S. Application Data
(60) Provisional application No. 63/368,286, filed on Jul. 13, 2022.

(51) Int. Cl. H04R 3/00; A61B 5/145; H04R 1/02; H04R 1/04; H04R 1/40

(52) U.S. Cl. CPC H04R 3/00; H04R 1/02; H04R 1/04; H04R 1/406; H04R 3/005

(57) ABSTRACT

An acoustic detection node for detecting at least a sound from at least one airborne vehicle within a detection zone is disclosed. The acoustic detection node comprises a frame and a plurality of acoustic sensors are adapted to be communicatively coupled to a processing module. The plurality of acoustic sensors include a sound capturing device for capturing the sound. A plurality of support posts project from the frame. The plurality of acoustic sensors are located at a free end of respective ones of the plurality of support posts. An acoustic tracking system to at least detect intrusions within a detection zone is also disclosed.

### CROSS-REFERENCE TO RELATED APPLICATION(S)

This application claims priority on U.S. provisional patent application 63/368,286 filed Jul. 13, 2022, the entire content of which is incorporated herein by reference.

### TECHNICAL FIELD

This application generally relates to acoustic tracking systems and, in particular, to acoustic detection apparatuses, and the like.

### BACKGROUND

Detection of airborne vehicles may be desirable in a number of applications. Surveillance of buildings, facilities, fields, secured areas, residential or industrial areas are some examples. In a particular application, an acoustic tracking system may be contemplated for prisons or other incarceration facilities which may require reinforced access control and/or detection and monitoring of intrusions for security purposes. Various detection systems and devices have been contemplated, yet components of at least some of them may not be robust enough to sustain long term use and/or northern weather conditions.

### SUMMARY

In accordance with a one aspect, there is provided an acoustic detection node for detecting at least a sound from at least one airborne vehicle within a detection zone, the acoustic detection node comprising: a frame; a plurality of acoustic sensors adapted to be communicatively coupled to a processing module, the plurality of acoustic sensors including a sound capturing device for capturing the sound; a plurality of support posts projecting from the frame, the plurality of acoustic sensors located at a free end of respective ones of the plurality of support posts.

Further in accordance with the above aspect, for example, the acoustic detection node further comprises a defrost system for heating at least a respective one of the plurality of acoustic sensor.

Further in accordance with the above aspects, for example, the acoustic detection node further comprises a processing module communicatively coupled to the plurality of acoustic sensors, the defrost system controllable via the processing module.

Further in accordance with the above aspects, for example, the defrost system is selectively activated/deactivated based on weather conditions and/or ambient temperature.

Further in accordance with the above aspects, for example, at least part of the defrost system is embedded onto the sound capturing device of the plurality of acoustic sensors.

Further in accordance with the above aspects, for example, the heating element includes a resistive circuit embedded onto the sound capturing device.

Further in accordance with the above aspects, for example, respective ones of the plurality of acoustic sensors include a cover surrounding the free end of respective ones of the support posts.

Further in accordance with the above aspects, for example, the cover includes a hydrophobic foam, the cover made at least partially by the hydrophobic foam.

Further in accordance with the above aspects, for example, the plurality of acoustic sensors have a three dimensional arrangement.

Further in accordance with the above aspects, for example, the three dimensional arrangement defines a pyramidal shape, such that the plurality of sensors are incrementally higher toward a center.

Further in accordance with the above aspects, for example, the plurality of support posts supporting respective ones of the plurality of acoustic sensors have respective upright projection incrementally greater in the outside-in direction.

Further in accordance with the above aspects, for example, the pyramidal shape is uniform.

Further in accordance with the above aspects, for example, the three dimensional arrangement is sized as a function of a processing module sampling frequency of the acoustic detection node.

Further in accordance with the above aspects, for example, a minimum distance between adjacent ones of the plurality of acoustic sensors is between 50 mm and 500 mm.

Further in accordance with the above aspects, for example, a space is defined between the free end of respective ones of the plurality of support posts, wherein the space is free of any surrounding structures.

Further in accordance with the above aspects, for example, the frame includes a plurality of frame members in the form of elongated rods spaced apart from each other in a plane having a vertical vector normal thereto, the plurality of frame members projecting from a central body of the acoustic detection node, the plurality of support posts projecting upwardly from the plurality of frame members.

Further in accordance with the above aspects, for example, the plurality of support posts have at least one of the following characteristics: the plurality of support posts have a cross-section at the free end with a sum of the cross-sections at most 1% of a total footprint of the acoustic detection node when viewed from above the acoustic detection node in its normal orientation in use; the plurality of support posts are vertical; the plurality of support posts are tubular; and the plurality of support posts have an upright projection and a dimension D2 transverse to the upright projection, the dimension D2 is smaller than the upright projection.

Further in accordance with the above aspects, for example, the plurality of frame members have at least one of the following characteristics: the plurality of frame members have a longitudinal projection L and a transverse dimension D1 that is transverse to the longitudinal projection L, the transverse dimension D1 is at most 10% of the longitudinal projection L; the plurality of frame members are tubular; the plurality of frame members extend at a similar relative angle in between them; and the plurality of frame members extend in a straight manner from the central body.

In accordance with another aspect, there is provided an acoustic tracking system to at least detect intrusions within a detection zone, the system comprising: a plurality of acoustic detection nodes in accordance with any one of the above aspects; and a monitoring module operatively connected to the plurality of acoustic detection nodes, the monitoring module receiving at least one of a signal indicative of a detection or location of intrusion within the detection zone and a signal indicative of an absence of intrusion from at least one of the plurality of acoustic detection nodes.

Further in accordance with the above aspect, for example, the acoustic tracking system further comprises at least one camera for visually validating the detected intrusions within the detection zone, the at least one camera is operatively connected to the monitoring module, wherein the monitoring module receives at least one of a signal indicative of a visual validation of the detection of intrusion and a signal indicative of an absence of visual validation from the at least one camera.

### BRIEF DESCRIPTION OF THE DRAWINGS

FIG. 1 is a schematic representation of an acoustic tracking system, according to the present disclosure.

FIG. 2 is a perspective view of an acoustic detection node of the acoustic tracking system of FIG. 1, according to an embodiment.

FIG. 3 is an exploded perspective view of an acoustic sensor of the acoustic detection node of FIG. 2, according to an embodiment.

FIG. 4 is a block diagram of a processing module of an acoustic detection node of the acoustic tracking system of FIG. 1, according to an embodiment.

FIG. 5 is a perspective view of an acoustic detection node of the acoustic tracking system of FIG. 1, according to another embodiment.

FIG. 6 is a side elevation view of the acoustic detection node of FIG. 5, shown with a partial cut-out;

FIG. 7 is an exploded view of an acoustic sensor of the acoustic detection node of FIG. 5, according to an embodiment.

FIG. 8 is a perspective view of a variant of the acoustic detection node of FIG. 5.

FIG. 9 is a top view of a variant of the acoustic detection node of FIGS. 2 and 5-6.

### DETAILED DESCRIPTION

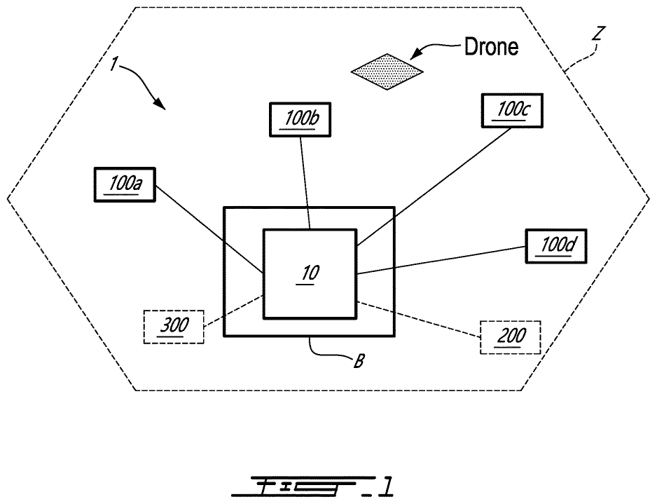

FIG. 1 illustrates a schematic representation of an acoustic tracking system 1. The acoustic tracking system 1 according to the present disclosure is configured to detect intrusions of an airborne vehicle within a detection zone Z. The acoustic tracking system 1 may also locate the position of the detected airborne vehicle. One or more airborne vehicles may be simultaneously detected and located. In a particular application exemplified in FIG. 1, the acoustic tracking system 1 is suitable for detection of intrusions within such a detection zone Z by airborne objects, and/or locating the position of such objects, in particular drone(s) or other remotely controlled unmanned airborne vehicles. Other airborne vehicles/objects could be detected/localized in other applications, such as airplanes, helicopters, etc.

The detection zone Z may surround an outside environment of a building B, such as a prison, a detention facility or other types of building (e.g., residential buildings, commercial/industrial buildings). It is understood that the acoustic tracking system 1 could be in operation for other applications, such as for surveillance of other infrastructures, such as yards or other environments which may require continuous, punctual, occasional and/or regular surveillance.

The acoustic tracking system 1 includes a monitoring station 10 and a plurality of acoustic detection nodes 100a, 100b, 100c, 100d, 100n communicatively coupled to the monitoring station 10. For simplicity, the nodes 100a, 100b, 100c, 100d, 100n, are jointly referred to as nodes 100 herein below. Moreover, while FIG. 1 shows four nodes 100, there may be fewer or more than the four nodes 100 shown. The monitoring station 10 and the nodes 100 form parts of a tracking or detection network. While the term nodes is consistently used herein, such nodes could also be referred to as detection units or detection terminals without departing from the intended scope.

The monitoring station 10 may include one or more servers, monitors, data storage, computer, etc. to collect, store, process, and/or compute data and/or signal indicative of a detection or absence thereof and/or location within the detection zone Z from the nodes 100. The monitoring station 10 may be referred to as a monitoring module, which may be portable or stationary.

Each node 100 is communicatively coupled to the monitoring station 10. Data and/or signals indicative of a detection or absence thereof, and/or indicative of a location, may be conveyed to the monitoring station 10 by wired connection, or wireless connection, depending on the embodiment. In an embodiment, the nodes 100 are communicatively coupled with the monitoring station 10 via an Ethernet connection. The nodes 100 may be communicatively coupled to the monitoring station 10, and/or between them via different connection configurations, such as daisy chain. For example, one or more nodes 100 may relay the data/signals received from other nodes 100 to the monitoring station 10. Other communication configurations may be contemplated, such as one or more of the nodes 100 communicatively coupled to the monitoring station 10, and some nodes 100 communicatively coupled to other ones of the nodes 100 relaying information to the monitoring station 10.

As will be described further later, the acoustic tracking system 1 disclosed herein is configured to at least detect, locate and monitor source(s) of noise or sound, referred to as acoustic waves, via such nodes 100. In an embodiment, the sound to be detected by the acoustic tracking system 1 is the sound that is associated with the operation of unmanned vehicles. Such sound may be within given frequency ranges, as per the use of electric motors, vibrations and fluid interaction with propellers or other propulsion means, for example. Accordingly, the acoustic tracking system 1 may be capable of filtering out some non-relevant noise to detect sound caused by unmanned vehicles. In at least some embodiments, the acoustic tracking system 1 is capable of validating the type of the detected sound by acoustic characterization, via signal processing. The acoustic tracking system 1 may thus validate the type of the sound source via its acoustic signature, such as by signal processing. Manned vehicles could also be detected, and located by the same technique. In some embodiments of the acoustic tracking system 1, imaging devices, such as one or more lidar 200, camera(s) 300, or the like, may be complementary detection media.

For example, the lidar 200 may be operated for detection, location, and/or monitoring of ground based intrusions, e.g., an operator on the ground controlling an unmanned vehicle, such as a drone. The lidar 200 could also be contemplated to provide complementary airborne detection in combination with the acoustic detection for even greater detection capacities in various environment and conditions. In the schematic representation of FIG. 1, lidar 200 is shown as a distinct detector separate from the nodes 100. The lidar 200 may be part of one of said nodes. Each node 100 may have a lidar 200 integrated therewith in at least some embodiments.

Similarly, camera 300 may refine the detection in addition to the acoustic detection via the nodes 100. The camera 300 may provide visual support for an operator to visualize the detection data at the monitoring station 10. The camera 300 may be operatively connected to the monitoring station 10. The camera 300 may assist the operator in visually validating the presence of intrusions within the detection zone Z. For example, the camera 300 may have night vision or infrared capabilities in some cases. The camera 300 may provide additional data for visual identification and/or classification of detected objects.

The orientation of the camera 300 may be controlled based on the detection or a suspected detection of the airborne object(s) made by other components of the acoustic tracking system 1, such as the noise detected via the nodes 100. The camera 300 may be selectively turned on (if not already turned on) and aimed at a presumed source of sound/noise, after signal processing is done by the acoustic tracking system 1, pursuant to node detection. In at least some embodiments, the camera 300 may visually detect or assist an operator to validate the presence of intrusions within the detection zone Z by providing an image or an image stream to the monitoring station (e.g., a user interface, such as a monitor, for example). Such image or image stream may be in the form of a signal, either a wired signal or wireless signal. The signal received by the monitoring station 10 from the camera 300 may be at least one of a signal indicative of a visual validation of the detection of intrusion and a signal indicative of an absence of visual validation. The captured image or image stream may be processed in the processing module (described below) such as by image processing or camera 300 to provide a visual identification and/or validation of a presumed source of sound/noise (or absence thereof) at an aimed location. Such visual identification and/or validation provided by the camera 300 may be communicated to the monitoring station 10. The camera 300 may thus be considered as a device to validate the presence or absence of a presumed source of sound/noise, in addition to the acoustic detection and location via the node(s) 100 and acoustic characterization. For example, one or more of the node(s) 100 may at least detect the potential presence of an aircraft in the detection zone Z, to trigger an active visual detection by the camera 300. Image processing may then be used from the camera footage to confirm the presence of a flying object in the detection zone Z. In the schematic representation of FIG. 1, the camera 300 is shown as a distinct detector separate from the nodes 100. The camera may be part of one of said nodes 100. Each node 100 may have the camera 300 integrated therewith in at least some embodiments.

These exemplary imaging devices 200, 300 may advantageously provide high imaging resolution to obtain valuable data to work with for the detection, the location, the monitoring and the classification of objects. The combination of acoustic and image detection devices as part of the acoustic tracking system 1 may provide an even more robust multimedia detection. However, the imaging devices 200, 300 are optional. The acoustic tracking system 1 with acoustic detection via the nodes 100 may work as a standalone system, without these imaging device 200, 300.

Features of the nodes 100 will now be described in further detail with reference to the following figures.

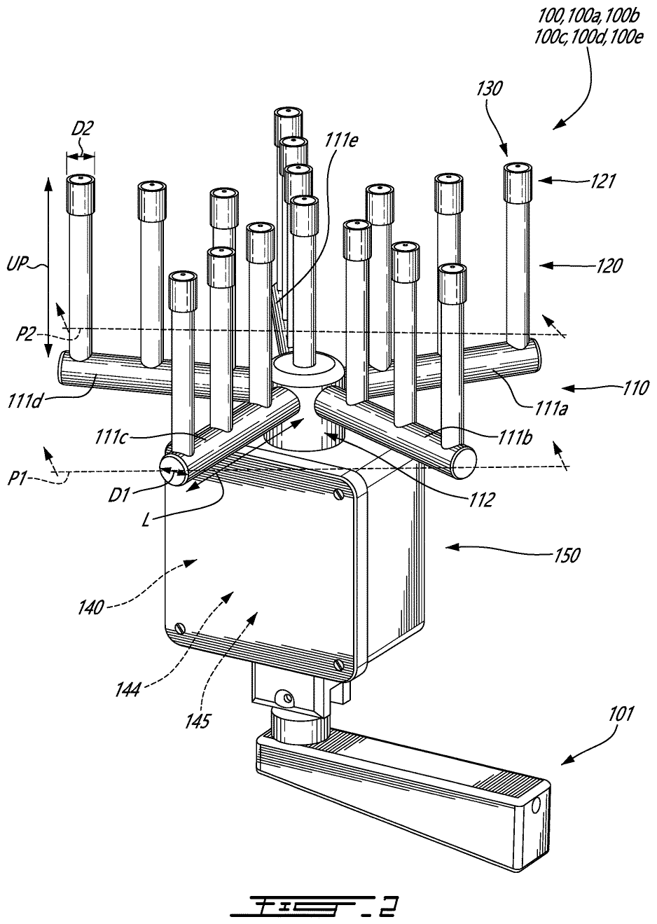

FIG. 2 is a perspective view of a node identified at 100. The node 100 of FIG. 1 may correspond to the node 100 presented herein in various embodiments. For simplicity, node 100 will be identified throughout of the disclosure.

The node 100 may be fixed to a roof or a wall, such as a wall of the building B, a post, a fence, an antenna, or other fixed structure, via a mounting structure 101 adapted therefor as a possibility among others. The structure 101 may have a joint, such as a ball joint, at its end, to allow angular adjustment of the node 100. The mounting may be via fasteners or other suitable connection on the fixed structure. The node 100 could be mounted on a mobile object, such as a vehicle, in other variants. In some embodiments, the node 100 may be mounted within a protecting structure. The node 100 may be surrounded by such protecting structure to protect the node 100 from impact by foreign objects (e.g., projectile) and/or limit mechanical damages to the node 100. In some variants, such protecting structure includes a mesh guard, for example.

The node 100 includes a frame 110 from which a plurality of support posts 120 project upwardly. A plurality of acoustic sensors 130 adapted to be operatively linked to a processing module 140 are located at a free end of respective ones of the plurality of support posts 120. Such a structural configuration of the frame 110 and support posts 120 projecting upwardly therefrom may provide a passive snow management mechanism, thereby limiting the influence of snow and accumulation thereof on the node 100 on the sound detection capabilities. Indeed, the footprint of the frame 110 and support posts 120 is small due to the elongated components thereof.

In an embodiment, the node 100 has a total of fifteen acoustic sensors 130. There could be more or less in other embodiments, such as between six and sixteen or between six and thirty-two, with the possibility of having fewer than six acoustic sensors 130 and more than thirty-two acoustic sensors 130. The total number of acoustic sensors 130 may be limited or dictated by the number of general purpose input/output ports available on a microchip of the processing module 140, or other electronic circuits forming part of the processing module 140. The signal processing capacities of the detection signals from the plurality of sensors 130 of the node 100 may also factor in. Having a plurality of acoustic sensors 130 forming a field/array of sensors 130 may allow for a gain in detection and location precision. The plurality of acoustic sensors 130 may acquire sound redundantly. As such, by setting a relative position between such sensors 130 in the computation parameters of the processing module 140, and via signal processing, noise filtering may more efficiently occur, and detection/localization of the source of sound may be performed. The processing module 140 adapted to process data or signal from more or less than fifteen acoustic sensors 130 at a time could be contemplated. Features of the acoustic sensors 130 and the processing module 140 will be described later herein below.

The frame 110 is adapted to minimize a footprint of the node 100 when viewed in a plane P1 having a vertical vector normal thereto, i.e., in a top plan view. The frame 110 includes a plurality of frame members 111a, 111b, 111c, 111d, 111e (or for simplicity, referred to herein as frame members 111). When viewed from the plane P1, the footprint occupied by the frame members 111 is relatively small when compared to the empty space (or “void”) in between them. As shown the frame members 111 are elongated rods spaced apart from each other in the plane P1. The frame members 111 have a transverse dimension D1 (dimension transverse to their longitudinal projection L) which may be minimized to obtain a small footprint compared to the empty space (or “void”) in between them. In an embodiment, the transverse dimension D1 of the frame members 111 is at most 10% of the longitudinal projection L of the frame members 111. It could be greater in other variants, such as between 10% and 15%, as another possibility, etc. Minimizing the footprint of the node 100 as described above may limit snow accumulation on the node 100, which may limit the impact of the environment on the acoustic detection via the sensors 130.

In the embodiment shown, the frame 110 includes a plurality, here five, frame members 111 extending at a similar relative angle in between them (e.g., 70 degrees±5 degrees.). This is only some possibilities, as there could be more or less frame members, positioned differently one with respect to the others, and/or extending in a non-straight manner (e.g., curved, sinusoidal, or irregularly extending). The plurality of frame members 111 originate from a central body 112, or hub. Stated otherwise, the frame members 111 project from the central body 112, in respective directions away from the central body 112, such as a radial direction in a variant. The plurality of frame members 111 and the central body 112 are identified as separate parts, though these parts could be formed as an integral piece, such as by molding, casting, welding, or other techniques to form a permanently assembled component.

The support posts 120 project upwardly from the frame members 111. The support posts 120 have a free end 121 which lies at an elevation above the frame 110. The support posts 120 have an upright projection UP and a dimension D2 transverse to the upright projection, the dimension D2 is substantially smaller than the upright projection UP. Such relationship is similar to that discussed above with respect to the dimensions D1 and L of the frame members 111. In an embodiment, a ratio of the transverse dimension D2 of such a support post 120 over its upright projection UP is at most 10%, though it could more. In an embodiment, the support posts 120 are vertical; however, the support posts 120 could extend upwardly at an angle relative to the frame members 111 or plane P1. For example, the support posts 120 could be oriented so as to have their respective free end 121 spaced along a spherical/hemispherical plane, with the position of each free end 121 defined by spherical coordinates in such plane. The support posts 120 have a limited cross-section so as to limit the total footprint of the node 100 when viewed from a top view (or above the node 100 in its normal orientation in use). In an embodiment, the plurality of support posts 120 have a cross-section at the free end 121 with a sum of the cross-sections no more than 1% of the total footprint of the node when viewed from a top view, or above the node 100 in its normal orientation in use. The proportion could be between 1% and 3% in some embodiments, for instance. Other proportions could be contemplated, such as proportions greater than 3%. As stated above, minimizing the total footprint of the node 100 is one way to passively manage the accumulation of snow. The cross-sections of D1 and D2 may be circular, but other shapes are considered.

A space between the free end 121 of the support posts 120 is provided at least for similar reasons. As shown, the space between the support posts 120, at least above a plane P2 at an elevation above the plane P1 and parallel thereto, may be free of any surrounding structures. In some variants, interconnecting rods, webs wires, or other structures could extend between the support posts 120 at an elevation above the plane P1 and/or P2.

Since the acoustic sensors 130 are located at the free end 121 of the support posts 120, it is desirable to limit the accumulation of snow about the sensors 130 to limit variations in the quality of the sound detection, which may be affected by interference with snow and/or ice build up on the free ends 121. The upright projection UP of the support posts 120 may be selected based on a balance between compactness of the nodes 100 and clearance between the sensors 130 and the frame 110 to mitigate risks associated with a potential snow accumulation on the structure other than by natural accumulation, such as from a sudden snow fall. In an embodiment, the support posts 120 may have an upright projection between 100 mm and 200 mm. Other dimensions could be contemplated, such as greater upright projection UP than in that range.

As shown, the support posts 120 are spaced apart from each other along respective ones of the frame members 111. In an embodiment, the spacing between adjacent ones of the support post 120 on a respective one of the frame members 111 is substantially equal (±5%). The support posts 120 could be unevenly distributed along a respective one of the frame members 111 in other embodiments.

The structural configuration of the node 100 may be selected based on an optimization of the distribution of acoustic sensors 130 and the spacing between them so as to obtain the desired accuracy and reliability of the acoustic measurements performed using the acoustic tracking system 1, node(s) 100 and the sounds detected therewith. For instance, a large distance between two adjacent ones of the acoustic sensors 130 may be better suited for detecting low-frequency sound sources. In contrast, a small distance between acoustic sensors 130 may minimize the hardware structural complexity and/or total footprint of the nodes 100. In an embodiment, a symmetrical assembly, where the sensors 130 are uniformly distributed around a central point is contemplated, as shown in FIG. 2. As shown, the acoustic sensors 130 span along a two-dimensional plane. Such relative positioning of the sensors 130 may allow locating a sound source with respect to an azimuth and an elevation taken relative to said plane. In at least some embodiments, the node 100 may be positioned so as to have such two-dimensional plane parallel to the ground. This may help to obtain a maximal coverage of the sound field in the detection zone Z. In an embodiment, as shown, the node 100 has three acoustic sensors 130 per frame member 111, with a total of five frame members 111 extending from the central body 112. In an embodiment, there may be a sixteenth sensor 130 located atop of the central body 112 at the free end 121 of a support post 120, but this is optional. This is merely an arrangement among others, as there may be fewer or more of the frame members 111, fewer or more of the support posts 120 per frame member 111, no acoustic sensor 130 on the central body 112, etc. In an embodiment, at least one of the acoustic sensor 130 may be repurposed for synchronization/calibration between the nodes 100. As such, one of the acoustic sensor 130 may be referred to as a reference sensor, which may be the sensor 130 located atop of the central body 112, as in FIG. 2. Other structural configurations of the node 100 could be contemplated. For example, the sensors 130 may be unevenly spaced apart, at different elevations, at a smaller or larger distance one with respect to the other, and/or not distributed around a central point.

In an embodiment, the frame members 111 and the support posts 120 are tubular, with internal channels defined for internal routing of cables. Wires extending from the acoustic sensors 130 at the free end 121 of the support posts 120 may be enclosed within the frame 110 and the support posts 120 for protection against tampering, environmental conditions or foreign objects, for example. The sensors 130 are adapted to be communicatively coupled to a processing module 140, as mentioned above. Such processing module 140 may be enclosed in a housing 150, as shown. Wires extending from the acoustic sensors 130 may extend through the support posts 120 and the frame members 111 and connect to the processing module 140 enclosed in the housing 150. The frame members 111 and the support posts 120 may be made of polymeric material, such as plastic, in at least some embodiments, but other materials are contemplated, such as aluminium, titanium, or composite materials.

In an embodiment, the housing 150 defines a base upon which the frame 110 is mounted. As shown, the central body 112 of the frame 110 is mounted atop the housing 150. This is only one possibility, as such housing 150 could be located remotely from the frame 110, such as fixed onto the fixed or mobile structure to which the nodes 100 is mounted. In the embodiment shown, the housing 150 is coupled to the mounting structure 101. The mounting structure 101 and the frame 110 could be coupled directly to one another, without the housing 150 between them, in embodiments where the housing 150 is absent, for example, or where the processing module 140 is remote to the nodes 100.

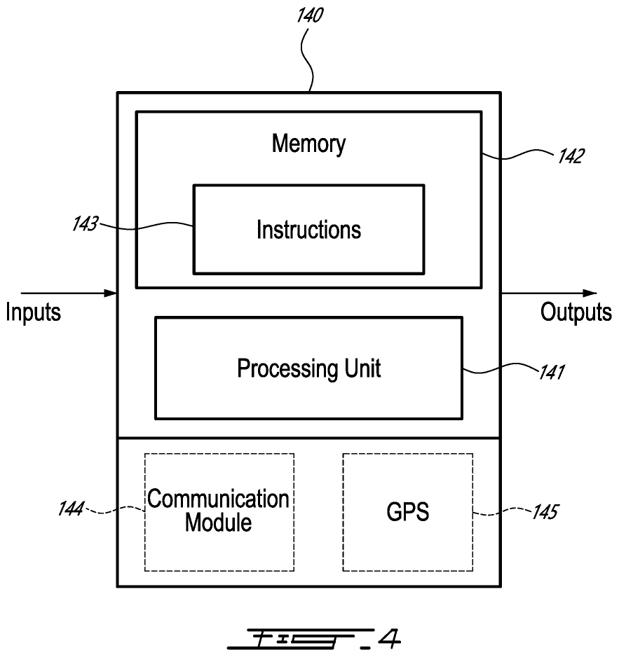

The housing 150 may enclose a number of electronics components for the processing, monitoring, storage and/or communication of data and/or detection signal indicative of a detected intrusions (or absence thereof). In embodiments where the node 100 includes lidar 200 and/or camera 300 integrated therewith, the housing 150 may enclose at least part of the components thereof. Such components may include electronic circuits, chips, microchips and other hardware, and/or software stored in a computer-readable medium to implement functions of the lidar 200 and/or camera 300, in addition to implementing operative functions for the sensors 130 and communicative (wired or wireless) functions for the node 100. In at least some embodiments, the housing 150 may include a communication module 144 (FIG. 4), whether part of the processing module 140 or not, adapted to communicate with the monitoring station 10 (or communicate with other nodes 100). In some embodiments, the housing 150 could enclose a power source, such as a battery, as an energy storage distinct from the ground electricity network, with solar power generation being an option. In some embodiments, the housing 150 may enclose a geolocation module 145 (e.g., using GPS—global positioning system), whether part of the processing module 140 or not, adapted to provide the geolocation of the node 100, such as the geolocation of the node 100 relative to the monitoring station 10 or relative geolocations of a plurality of nodes 100. Any or all of the above may be part of what is referred to herein as the processing module 140. Other aspects of the processing module 140 are further described herein later. A shape of the housing 150 may be selected so as to limit its footprint, for the same reasons as provided above with respect to the frame 110 and its components, namely to limit snow accumulation. For example, a top surface of the housing 150 may be non-flat, or angled (e.g., conical, pyramidal) so as to limit the accumulation of snow thereon. A compact housing 150 may also be desirable for this purpose, and/or to limit the impact of the wind thereon. A compact housing 150 may also be advantageous for its greater portability, for example in embodiments where the node 100 is adapted to be mounted on a mobile object instead of being fixed.

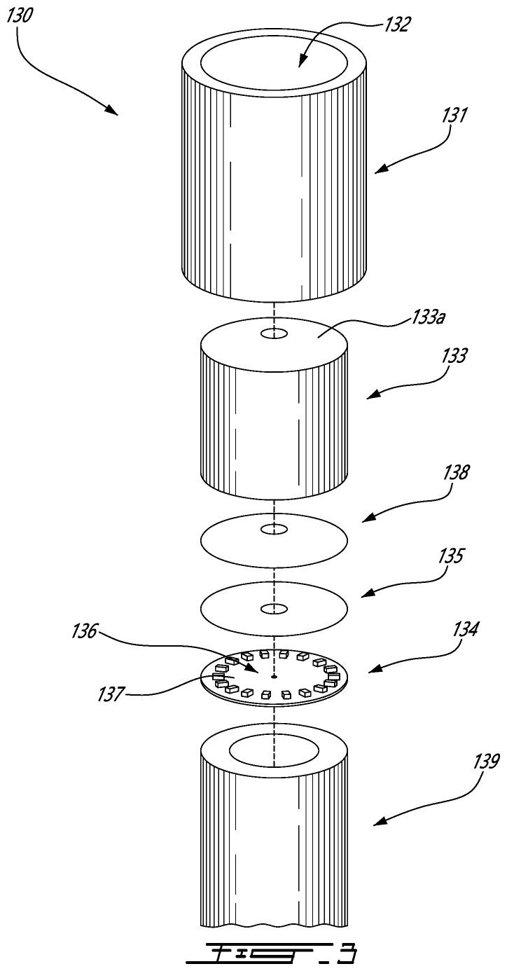

Features of the acoustic sensors 130 will now be described with reference to FIG. 3. Components of an acoustic sensor 130 are shown in FIG. 3. These components are located at the free end 121 of one of the support posts 120. A casing 131 defines a receptacle 132 containing at least part of the components of the acoustic sensor 130. In the embodiment shown, the casing 131 may be defined by a sleeve, which is tubular. The sleeve is coupled to the free end 121 of the support post 120. Coupling may be done by bonding (e.g., using adhesives) the sleeve to the free end 121 of the support post 120, by fasteners, welding or other coupling means. The sleeve may be in sealing engagement with the free end 121 in at least some embodiments. The casing 131 may be part of the support post 120, as opposed to being part of the sensor 130.

In the embodiment shown, the sleeve is aligned concentrically with the free end 121 of the support post 120. The sleeve may protect the electronics of the sensor 130 from the surrounding environment. In an embodiment, the casing 131 is made of a thermoplastic material. In a particular embodiment, the thermoplastic material includes chlorinated polyvinyl chloride (CPVC). Such material has a great resistance to temperature changes, e.g., heat, and ultraviolet radiations. Such material may thus be less impacted over time from extended use outdoor, under changing weather conditions. Metallic materials or other non-metallic materials, such as aluminium or titanium, could be used in other embodiments. In the embodiment shown, the casing 131 has a top end that is open to the environment. The casing 131 surrounds or “walls” at least the electronic components of the acoustic sensor. The casing 131 may form a sealed enclosure for receiving the electronic components of the sensor 130, with a closed top end, in other embodiments.

A tip of the sensor 130 may include a sheath 133 of electrically insulated material. The sheath 133 defines a protective cap surrounding at least part of the components of the acoustic sensor 130. As shown, the sheath 133 extends peripherally about the sound capturing device 134 (described below). The sheath 133 also defines a top end 133a. The top end 133a has a disc shape in the embodiment shown, so as to follow the outline of the sheath 133. As shown, the sheath 133 has a peripheral outline which corresponds in shape with that of the casing 131. Such peripheral outline is cylindrical, though other shapes may be contemplated in other embodiments, such as square, polygonal, etc. In an embodiment, the top end 133a has a non-flat top surface. The top end 133a may have a cup shape, hemispherical shape, a conical shape, a pyramidal shape or other convex or tapered shape. Such as non-flat surface at the tip of the sensor 130 may prevent or at least limit water accumulation on the tip. Water accumulation on the tip could affect the sound detection in at least some embodiments. When assembled with the casing 131, the sheath 133 is surrounded, at least peripherally, by the casing 131. Stated otherwise, the sheath 133 is within the casing 131. As shown, the sheath 133 may define the closed top end of the casing 131, in embodiments where the casing 131 does not have such close top end. Stated otherwise, although the sheath 133 is within the casing 131, the top end 133a of the protective cap may be exposed to the environment.

In an embodiment, such sheet is a polytetrafluoroethylene (PTFE) sheet. Such PTFE sheath 133 may protect the electronics from water, dust, and UV light. Such material may advantageously resist to heat, and deterioration via extended exposition under UV light. In the embodiment shown, the PTFE sheath 133 defines a taper, conical or other non-flat convex surface at the tip of the sensor 130, which may correspond to the extremity of the free end 121 of the support post 120.

As shown, the casing 131 encloses the sound capturing device 134. The sound capturing device 134 is in the form of a circuit such as printed circuit board (PCB), though the sound capturing device 134 may also be viewed/defined on a microchip, such as a system-on-a-chip (SoC), with a number of general-purpose input/output (GPIO), integrated sound bus (12S), for example. The sound capturing device 134 is integrated onto or defined by a circuit board having a disc shape to accommodate the shape of the casing 131 and/or support post 120. Other shapes could be contemplated in other embodiments, such as square, or polygonal. The sound capturing device 134 has a sound capturing component such as one or more microphones, sound processing components and/or filters.

The casing 131 and the sheath 133 described above cover the circuit of the sound capturing device 134. As shown, a polyimide film 135 (or “foil”) overlays the circuit of the sound capturing device 134. The polyimide film 135 may be a Kapton® film/foil such as those commercialized by DuPont™. Other materials are contemplated, such as other film with high electrical insulation properties, and high fusion point. The polyimide film 135 may be laminated or coated on the circuit of the sound capturing device 134 in at least some embodiments. The polyimide film 135 may protect, or at least contribute to the protection of the sound capturing device 134 against short circuit or spark caused by static electricity, for example.

In an embodiment, such as shown, the acoustic sensor 130 includes a defrost system 136. The defrost system 136 may be an electric resistive wire that may heat the tip of the sensor and/or free end 121 of the support post 120, so as to melt or limit accumulation of snow, ice and/or frost at the free end 121. At least part of the defrost system 136 may be embedded onto the circuit board of the sound capturing device 134. The defrost system 136 includes a heating element 137. The heating element 137 may distribute heat over the whole sound capturing device 134. In the embodiment shown, the heating element 137 includes a resistance circuit embedded onto the circuit board of the sound capturing device 134. The resistance circuit may include one or more heating resistor onto the surface of the circuit board. The heating element 137 may be part of a circuit board separate from that of the sound capturing device 134 in other embodiments, or may include a heating coil extending from the circuit 134 or from the processing module 140 to heat the casing 131 or post 139. The heating element 137 may overlay the polyimide film 135, or underlay the circuit of the sound capturing device 134, for example. The heating element 137 could also surround the sound capturing device 134 in other embodiments, such as along the internal periphery of the casing 131, external periphery of the sheath 133, or internal periphery of the sheath 133. These are some possibilities.

The defrost system 136 may be supplied by a power source, such as a battery, solar power, electricity supply, or other forms of power supplies. Such power source may be enclosed in or pass through the housing 150 (discussed above). The defrost system 136 may be controllable via the processing module 140, and/or remotely by operators of the monitoring station 10. The defrost system 136 may be selectively activated/deactivated, based on whether conditions or ambient temperature, or remain activated continuously, depending on the embodiments.

The defrost system 136 may form part of each sensor 130 of the node 100. Stated otherwise, each sensor 130 may includes one such defrost system 136, independently. A single defrost system 136 may include a plurality of heating elements 137 in respective ones of the sensor 130 in other embodiments. Some or all sensors 130 of the node 100 could not have such defrost system 136, even though such system 136 is particularly advantageous in most cases, in particular when the nodes 100 are installed in northern countries, with sub-zero temperature conditions and/or snowy conditions. With the defrost system 136, the node 100 may have both a passive snow management mechanism by its structural configuration discussed above and an active snow management system defined by the defrost system 136.

In at least some embodiments, the sensor 130 includes a highly thermally conductive sheet of material. As shown, the sensor 130 includes a disc 138 overlying the polyimide film 135, the disc 138 being the highly thermally conductive sheet of material. In an embodiment, the disc 138 is an aluminium disc. Other thermally conductive material could be contemplated, such as copper. A metal sheet, such as a steel sheet could also be contemplated in other embodiments. The disc 138 may be heated by the heating element 137. Heat may be more evenly distributed over the entire sound capturing device 134 via the disc 138. While the highly thermally conductive sheet of material has a disc shape, other shapes could be contemplated. The sheet of material in the form of disc 138 could have any other shape corresponding to that of the sound capturing device 134 so as to more evenly distribute heat over the surface of the circuit of the sound capturing device 134.

In an embodiment, the disc 138 has a non-flat top surface. The top surface of the disc 138 may have a shape corresponding to that of the sheath 133 of PTFE discussed above. The disc 138 may have a conical shape, or other shapes, such as that discussed above with respect to the top end surface of the sheath 133. As shown, the sheath 133, the sound capturing device 134, the polyimide film 135, and the disc 138 of highly thermally conductive sheet of material are stacked one onto the another. All of these components may be enclosed or at least surrounded by the casing 131, as discussed above.

The sensor 130 includes a microphone tube 139, which is immediately under the the circuit of the sound capturing device 134. The microphone tube 139 may define a compartment, which may be sealed, to enclose other electronic components of the sensor 130, such as a signal receiver, transducers, etc. The microphone tube 139 is immediately adjacent to the circuit of the sound capturing device 134 so as to limit a distance between the circuit and other components of the sensor 130. This may advantageously provide a greater signal-to-noise ratio, by limiting the wiring between the electronic components of the sensor 130. Although this configuration is desirable in at least some embodiments, the microphone tube 139 could be spaced apart further from the circuit in other embodiments. The microphone tube 139 is made of CPVC in an embodiment for its advantageous properties discussed above. Other material could be contemplated, such as metallic material, such as steel, or other materials, such as aluminium, titanium, etc., The microphone tube 139 may be sealed so as to protect the electronic components enclosed therein. The microphone tube 139 may define at least part of the free end 121 of the support post 120. The microphone tube 139 may advantageously distance the sensors 130 from the remainder of the structure of the node 100, including the posts 120. The microphone tube 139 may electromagnetically and/or electrically “isolate” the sensors 130 from the structure of the node 100. The microphone tube 139 may form part of the support post 120 in some embodiments. For example, the microphone tube 139 may be part of the tubular support post 120, or the microphone tube 139 could be coextensive with the support post 120, as some possibilities.

Further aspects of the processing module 140 will now be described with reference to FIG. 4, which illustrates schematically the processing module 140. The processing module 140 may include a processing unit 141 and a memory 142 which has stored therein computer-executable instructions 143. The memory 142 may also store other relevant information for the implementation of the processes, such as algorithms. The processing unit 141 may include any suitable device configured to implement the functionality of the processing module 140 such that instructions 143, when executed by the processing unit 141 or other programmable apparatus, may cause at least some of the functions of the node 100 and/or acoustic tracking system 1. The processing unit 141 may include, for example, any type of general-purpose microprocessor or microcontroller, a digital signal processing (DSP) processor, a central processing unit (CPU), an integrated circuit, a printed circuit board (PCB), other suitably programmed or programmable logic circuits, custom-designed analog and/or digital circuits, or any combination thereof. The memory 142 may comprise any suitable known or other machine-readable storage medium. The memory 142 may comprise non-transitory computer readable storage medium, for example, but not limited to, an electronic, magnetic, optical, electromagnetic, infrared, or semiconductor system, apparatus, or device, or any suitable combination of the foregoing. The memory 142 may include a suitable combination of any type of computer memory that is located either internally or externally to device, for example random-access memory (RAM), read-only memory (ROM), electro-optical memory, magneto-optical memory, or the like. The memory 142 may comprise any storage means (e.g., devices) suitable for retrievably storing machine-readable instructions 143 executable by processing unit 141. Input data or signal may be received at the processing module 140, for instance from the sensors 130 of the node 100. The processing module 140 may process and convey output data or signals to the monitoring station 10 for further processing, for visualisation, analysis, monitoring or storage, or a combination thereof, for example. Security protocols in the building B may be activated based upon the detection of suspicious activities or intrusions within the detection zone Z.

Referring to FIGS. 5-7, other aspects of the detection node 100 described above will now be described with references to another exemplary detection node referred to at 1000. For conciseness, the aspects discussed above with respect to the detection node 100 will not be repeated in their entireties with respect to the detection node 1000; however it should be understood that features described above may similarly apply to the corresponding features of the detection node 1000. Similar features of the detection nodes 1000 with respect to detection node 100 will bear corresponding reference numerals in the 1000s for ease of reference.

As shown, the detection node 1000 includes a mounting structure 1101, a frame 1110, frame members 1111a, 1111b, 1111c, 1111d (hereinafter frame members 1111 for convenience), a central body 1112, support posts 1120, acoustic sensors 1130 at a free end 1121 of the posts 1120. The detection node 1000 includes a processing module 1140 and a housing 1150.

In the embodiment shown, the acoustic sensors 1130 include a cover 1130C, which may also be referred to as a shield, and may be used with the sensors 130 described above. The cover 1130C may provide a windscreen to reduce the undesirable effect of wind noise on the sound detection. The cover 1130C may be capable of filtering out some non-relevant noise generated by the wind in the surrounding environment of the node 1000. The cover 1130C may include foam or other porous medium. The cover 1130C may be made partially or entirely from such foam or other porous medium. In an embodiment, the cover 1130C may include hydrophobic foam. Such a configuration having hydrophobic foam may limit the impact of water on the sound detection. For example, in the context of outdoor use, the node 1000 may be subject to high humidity and/or water, which could be absorbed by cover 1130C made of non-hydrophobic foam or porous medium and thus limit the detection distance, in some cases. As shown, the cover 1130C may surround the sides and top of the free end 1121 of the posts 1120, so as to provide a 360 degrees windscreen coverage. It may be desirable to limit the footprint of the cover 110C (in a top plan view) for the same reasons discussed above with respect to the frame 110. The cover 1130C may have a profile adapted to limit snow accumulation. Optionally, the cover 1130C may include one or more spikes projecting outwardly therefrom to prevent or limit bird perching or, other animal deterrent.

The spatial arrangement of the acoustic sensors 1130 is such that the detection tips of the plurality of acoustic sensors 1130 are positioned in a three dimensional space, in contrast to a planar arrangement, as shown in FIG. 2. As shown in FIG. 5, one or more acoustic sensors 1130 of the node 1000 may be at a different relative elevation with respect to at least some other acoustic sensors 1130 of the node 1000. A 3D-shaped array of acoustic sensors 1130, i.e., a set of acoustic sensors 1130 located in a virtual three dimensional body, may discriminate sound sources in a complete spherical region around the array. Such positioning of the acoustic sensors 1130 may better account for and filter out the sound wave reflection which may be caused by a proximity with a reflective object or the ground in proximity with the acoustic sensors 1130, through subsequent sound processing. Alleviating the sound wave reflection effect may provide a more precise detection and location of a sound source, whether such sound source is above or below the node 1000 in the surrounding space. The general orientation of the node 1000 relative to its surrounding space, or relative to the ground, may be adjusted during installation to achieve an optimized coverage of the sound field in the detection zone Z. For example, the positioning of the node 1000 may be such that at least some of the acoustic sensors 1130 of the node 1000 may be located at an equal distance from the ground directly below the node 1000 or from another location in the surrounding environment of the node 1000.

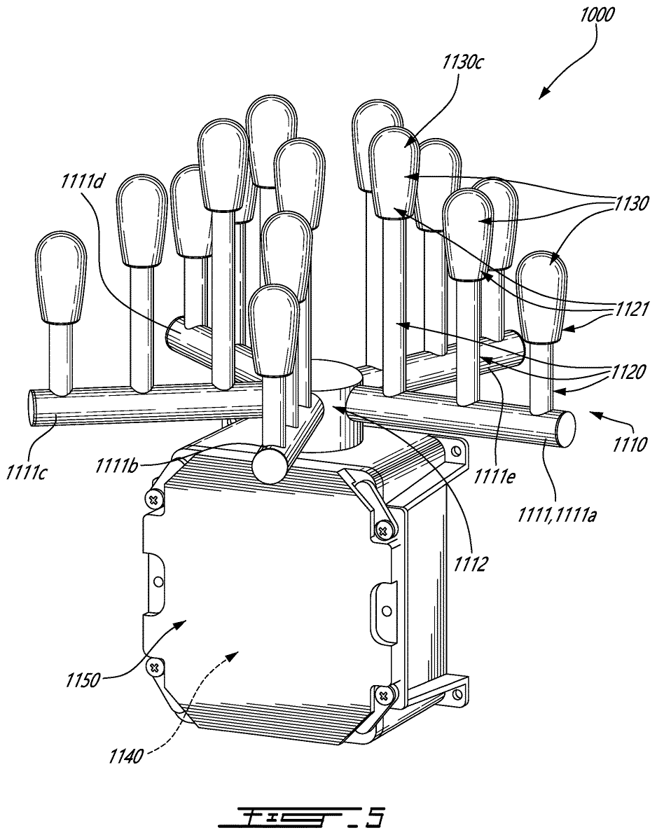

Referring to FIG. 5 and additional reference to FIG. 6, the three dimensional arrangement of the plurality of acoustic sensors 1130 generally defines a pyramidal shape. As shown, the acoustic sensors 1130 most radially outward relative to the central body 1112 are positioned at a lower elevation relative to the other acoustic sensors 1130 located more closely to the central body 1112. The acoustic sensors 1130 are incrementally higher in an outside-in direction. In the embodiment shown, such incremental elevation of the acoustic sensors 1130 may be obtained by having the upright projection UP of the support posts 1120 supporting their respective acoustic sensors 1130 incrementally greater in the outside-in direction to create such pyramidal shape arrangement of the acoustic sensors 1130. Another way of expressing this is that the arrangement of the acoustic sensors 1130 would result in the detection ends of the acoustic sensors 1130 contacting an inner surface of a virtual cone. A three dimensional arrangement may help to reduce the number of acoustic sensors 1130 exposed to turbulent flow caused by wind interaction with adjacent acoustic sensors 1130 and their corresponding support posts 1120. The acoustic sensors 1130 and their corresponding support posts 1120 create turbulent wake downstream thereof when exposed to an upstream wind coming towards the acoustic sensors 1130 (e.g., a side wind or transverse wind, for example). Positioning the outwardmost acoustic sensors 1130 at a lower elevation relative to adjacent ones of the acoustic sensors 1130 inwardly closer from the central body 1112 of the node 1000 reduces the number of acoustic sensors 1130 exposed to such turbulent flow. In the embodiment shown, the pyramidal shape is uniform along each frame member 1111. Each series of acoustic sensors 1130 and corresponding support posts 1120 along respective ones of the frame members 1111 defines a similar profile with a inwardly increasing elevation. This uniformity may simplify assembly and reduce the number of individual parts in the assembly as a whole; however, this is optional. For example, the spatial arrangement of the acoustic sensors 1130 could be non uniformly distributed in some variants. In some variants, such three dimensional arrangement of the plurality of acoustic sensors 1130 described above may be top down. Stated otherwise, the support posts 1120 supporting their respective acoustic sensors 1130 may project downwardly from respective ones of the frame members 1111. In such variants, the pyramidal shape described above may be pointing downwardly instead of upwardly. Another way of expressing this is that the arrangement of the acoustic sensors 1130 would result in the detection ends of the acoustic sensors 1130 contacting an inner surface of a virtual cone, where such virtual cone is upside down. It is also contemplated to have both, a set of support posts 1120 with sensors 1130 forming an upward pyramidal shape and another set of support posts 1120 with sensors 1130 forming a downward pyramidal shape, for example. Yet, in some variants, the node 1000 may include a set of support posts 1120 with sensors 1130 forming an upward pyramidal shape or downward pyramidal shape with one or more support posts 1120 with sensors 1130 extending in an opposite direction. These various configurations may provide different level of sensitivity to the detection of sounds/noise in the surrounding environment of the node 1000 (e.g., above and/or below the node 1000 once installed).

The size of the 3D-shaped array may impact its weight and structural integrity. A larger 3D-shaped array may require a proportionally sized overall structure that can support its own weight and/or limit deflection, including at the level of the frame members 1111, support posts 1120, etc. Larger arrays may be more tedious to install or transport, or be more sensitive to turbulences or vibrations caused by flow excitation or sources of vibrations, for example. The node 1000, including the 3D-shaped array, may be sized to limit the impact of wind and vibrations while still providing a sufficient spatial resolution of the sound field in the detection zone. In some embodiments, larger 3D-shaped arrays may provide a better spatial resolution of the sound field in low frequencies at the signal processing level.

In an embodiment, a minimum distance DD between adjacent ones of the acoustic sensors 1130 may be between 50 mm and 500 mm (measured center-to-center between acoustic sensors 1130). In a particular embodiment, the distance DD is 68 mm±10 mm. In an embodiment, a maximum distance DD between centers of adjacent ones of the acoustic sensors 1130 may be 338 mm±30 mm. The distance DD may be measured along a transverse plane, without considering the relative elevation of the adjacent acoustic sensors 1130. Other dimensions could be contemplated in some embodiments. In at least some embodiments, the 3D-shaped array is sized as a function of the sampling frequency of the processing module 1140. In an embodiment, the sampling frequency of the processing module 1140 is set at 16,000 Hz±100 Hz. In some alternatives, such interval could be larger, such as ±2,000 Hz. Such sampling frequency was found to be a desirable sampling frequency for the sound detection, however, other sampling frequencies, such as higher or lower sampling frequencies could be contemplated in some cases. In an embodiment under such sampling condition, the minimum distance DD between adjacent ones of the acoustic sensors 1130 may be 1.6±0.3 times the minimum wave length. Other relative distances between the acoustic sensors could be contemplated in other embodiments, where, for example, the sampling frequency is different.

With additional reference to FIG. 6, and as similarly described with respect to other embodiments above, the acoustic sensors 1130 are located at the free end 1121 of respective support posts 1120. The cover 1130C surrounds peripherally the acoustic sensor 1130. The cover 1130C may define a dome above the acoustic sensor 1130C. In at least some embodiments, such as shown, the cover 1130C may define a cavity 1130S above an upper face of the acoustic sensor 1130 and open to it, Such cavity 1130S may prevent the cover 1130C to contact the acoustic sensor 1130. In embodiments where such cover 1130C is made of foam, for example, small deflections or other deformations of the foam which may be due to an outside load (i.e., water, ice, snow, etc.), may not lead to contact with the acoustic sensor 1130. In other words, the cavity 1130S may allow deformation of the cover 1130C without a contact with the acoustic sensor 1130 over a limited range of deformation.

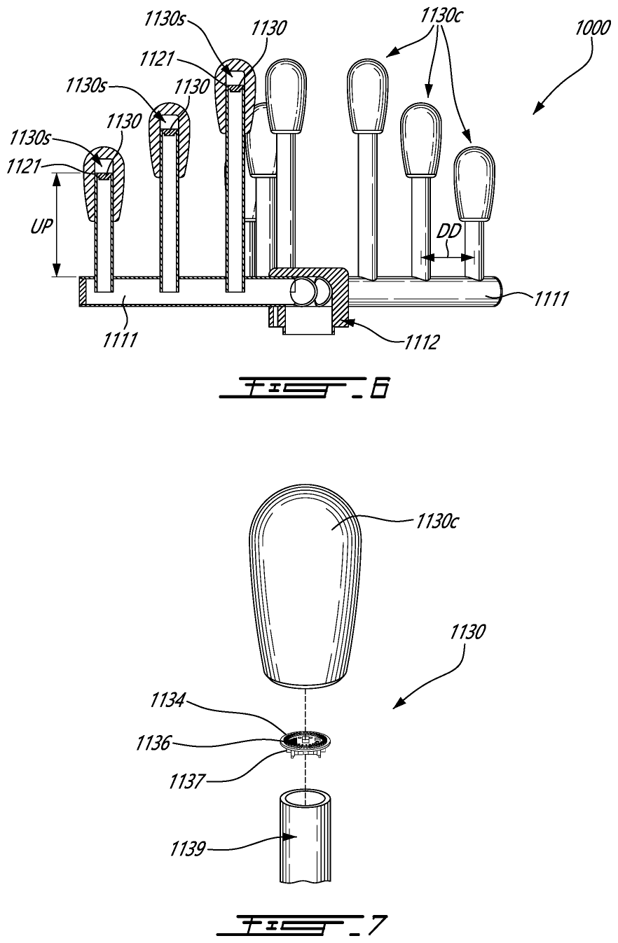

Referring to FIG. 7, components of an acoustic sensor 1130 are now described. A sound capturing device 1134 is supported at the free end 1121 of the support post 1120. The sound capturing device 1134 is in the form of a printed circuit board (PCB), though circuit 1134 may also be viewed/defined on a microchip, such as a system-on-a-chip (SoC), with a number of general-purpose input/output (GPIO), integrated sound bus (12S), for example. The sound capturing device 1134 is integrated onto or defined by a circuit board having a disc shape to accommodate the shape of the casing 1131 and/or support post 1120. Other shapes could be contemplated in other embodiments, such as square, or polygonal. The sound capturing device 1134 has a sound capturing component such as one or more microphones, sound processing components and/or filters.

The acoustic sensor 1130 includes a defrost system 1136 as similarly described above. The defrost system 1136 may be an electric resistive wire that may heat the tip of the sensor and/or free end 1121 of the support post 1120, so as to melt or limit accumulation of snow, ice and/or frost at the free end 1121. At least part of the defrost system 1136 may be embedded onto the circuit board of the sound capturing device 1134. The defrost system 1136 includes a heating element 1137. The heating element 1137 may distribute heat over the whole sound capturing device 1134. In the embodiment shown, the heating element 1137 includes a resistance circuit embedded onto the circuit board of the sound capturing device 1134. The resistance circuit may include one or more heating resistor onto the surface of the circuit board. The heating element 1137 be part of a circuit board separate from that of the sound capturing device 1134 in other embodiments. The heating element 1137 may overlay the sound capturing device 1134, or underlay the sound capturing device 1134, for example. The heating element 1137 could also surround the sound capturing device 1134 in other embodiments. These are some possibilities.

The defrost system 1136 may be supplied by a power source, such as a battery, solar power, electricity supply, or other forms of power supplies. Such power source may be enclosed in or pass through the housing 1150 (FIG. 5). The defrost system 1136 may be controllable via the processing module 1140 (FIG. 5), and/or remotely by operators of the monitoring station 10 (FIG. 1). The defrost system 1136 may be selectively activated/deactivated, based on whether conditions or ambient temperature, or remain activated continuously, depending on the embodiments.

The defrost system 1136 may form part of each sensor 1130 of the node 1000. Stated otherwise, each sensor 1130 may includes one such defrost system 1136, independently. A single defrost system 1136 may include a plurality of heating element 1137 in respective ones of the sensor 1130 in other embodiments. Some or all sensors 1130 of the node 1000 could not have such defrost system 1136, even though such system 1136 is particularly advantageous in most cases, in particular when the nodes 1000 are installed in northern countries, with sub-zero temperature conditions and/or snowy conditions. With the defrost system 1136, the node 1000 may have both a passive snow management mechanism by its structural configuration discussed above and an active snow management system defined by the defrost system 1136.

As described above with reference to acoustic sensor 130, the acoustic sensor 1130 may include a microphone tube 1139, which is immediately under the sound capturing device 1134. The microphone tube 1139 may define a compartment, which may be sealed, to enclose other electronic components of the sensor 1130, such as a signal receiver, transducers, etc. The microphone tube 1139 is immediately adjacent to the sound capturing device 1134 so as to limit a distance between the sound capturing device 1134 and other components of the sensor 1130. This may advantageously provide a greater signal-to-noise ratio, by limiting the wiring between the electronic components of the sensor 1130. Although this configuration is desirable in at least some embodiments, the microphone tube 1139 could be spaced apart further from the sound capturing device 1134 in other embodiments. The microphone tube 1139 is made of CPVC in an embodiment for its advantageous properties discussed above. Other material could be contemplated, such as metallic material, such as steel, or other materials, such as aluminium, titanium, etc. The microphone tube 1139 may be sealed so as to protect the electronic components enclosed therein. The microphone tube 1139 may define at least part of the free end 1121 of the support post 1120. The microphone tube 1139 may advantageously distance the sensors 1130 from the remainder of the structure of the node 1000, including the posts 1120. The microphone tube 1139 may electromagnetically and/or electrically “isolate” the sensors 1130 from the structure of the node 1000. The microphone tube 1139 may form part of the support post 1120 in some embodiments. For example, the microphone tube 1139 may be part of the tubular support post 1120, or the microphone tube 1139 could be coextensive with the support post 1120, as some possibilities.

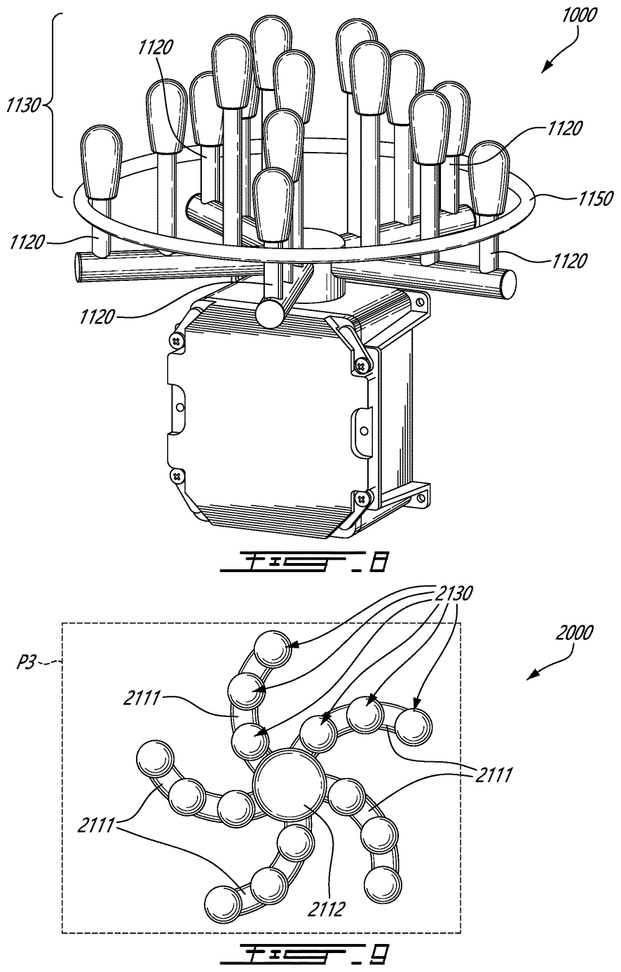

A variant of the detection node 1000 is shown at FIG. 8. Features already described above with respect to the detection node 1000 will not be described again for conciseness. In some variants, as shown, the detection node 1000 may include a protective ring 1150. The protective ring 1150 may surround the outwardmost support posts 1120. In some embodiments, the protective ring 1150 is coupled to a plurality of the support posts 1120. Such protective ring 1150 may provide an even more robust construction to maintain the integrity of the overall structure. The protective ring 1150 extends about the support posts 1120 at a lower elevation relative to the lowest ones of the acoustic sensors 1130 on the node 1000. Flow turbulence which may be caused by the presence of the protective ring 1150 in a flow of air may thus have little to no impact on the sound detection. While the protective ring 1150 is described with respect to the detection node 1000, the protective ring 1150 could also be found in at least some variants of the detection node 100 described earlier above.

Referring to FIG. 9, another variant of the detection node is shown at 2000. Again, features already described above with respect to various embodiments of the detection node will not be described again, but should nevertheless be understood as applying similarly to this variant. In this variant, the detection node 2000 includes a plurality of sensors 2130, such as the sensors 1130 described above. The sensors 2130 may be positioned in a planar configuration or three dimensional arrangement (e.g., hemispherical or spherical plane), as described herein. The relative positioning of the acoustic sensors 2130 viewed from a top of the acoustic node 2000 (as represented at FIG. 9) may form a galaxy shape, with the central body 2112 located at the origin thereof. As shown, each frame member 2111 is curved in the plane P3 having a vertical vector normal thereto. Curvature and/or direction of curvature of the frame member 2111 may be identical, as shown, but this is optional. Such shape may allow to reduce the number of the acoustic sensors on a common axis. This may even more reduce the effect of turbulent wake caused in the surrounding of an acoustic sensor 2130 on the adjacent ones of the acoustic sensors 2130.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An acoustic detection node for detecting at least a sound from at least one airborne vehicle within a detection zone, the acoustic detection node comprising:
a frame;
a plurality of acoustic sensors adapted to be communicatively coupled to a processing module, the plurality of acoustic sensors including a sound capturing device for capturing the sound;
a plurality of support posts projecting from the frame, the plurality of acoustic sensors located at a free end of respective ones of the plurality of support posts.

2. The acoustic detection node of claim 1, further comprising a defrost system for heating at least a respective one of the plurality of acoustic sensor.

3. The acoustic detection node of claim 2, further comprising a processing module communicatively coupled to the plurality of acoustic sensors, the defrost system controllable via the processing module.

4. The acoustic detection node of claim 2, wherein the defrost system is selectively activated/deactivated based on weather conditions and/or ambient temperature.

5. The acoustic detection node of claim 2, wherein at least part of the defrost system is embedded onto the sound capturing device of the plurality of acoustic sensors.

6. The acoustic detection node of claim 5, wherein the defrost system includes a heating element, the heating element includes a resistive circuit embedded onto the sound capturing device.

7. The acoustic detection node of claim 1, wherein respective ones of the plurality of acoustic sensors include a cover surrounding the free end of respective ones of the support posts.

8. The acoustic detection node of claim 7, wherein the cover includes a hydrophobic foam, the cover made at least partially by the hydrophobic foam.

9. The acoustic detection node of claim 1, wherein the plurality of acoustic sensors have a three dimensional arrangement.

10. The acoustic detection node of claim 9, wherein the three dimensional arrangement defines a pyramidal shape, such that the plurality of sensors are incrementally higher toward a center.

11. The acoustic detection node of claim 9, wherein the plurality of support posts supporting respective ones of the plurality of acoustic sensors have respective upright projection incrementally greater in the outside-in direction.

12. The acoustic detection node of claim 10, wherein the pyramidal shape is uniform.

13. The acoustic detection node of claim 9, wherein the three dimensional arrangement is sized as a function of a processing module sampling frequency of the acoustic detection node.

14. The acoustic detection node of claim 13, wherein a minimum distance between adjacent ones of the plurality of acoustic sensors is between 50 mm and 500 mm.

15. The acoustic detection node of claim 1, wherein a space is defined between the free end of respective ones of the plurality of support posts, wherein the space is free of any surrounding structures.

16. The acoustic detection node of claim 1, wherein the frame includes a plurality of frame members in the form of elongated rods spaced apart from each other in a plane having a vertical vector normal thereto, the plurality of frame members projecting from a central body of the acoustic detection node, the plurality of support posts projecting upwardly from the plurality of frame members.

17. The acoustic detection node of claim 16, wherein the plurality of support posts have at least one of the following characteristics:
the plurality of support posts have a cross-section at the free end with a sum of the cross-sections at most 1% of a total footprint of the acoustic detection node when viewed from above the acoustic detection node in its normal orientation in use;
the plurality of support posts are vertical;
the plurality of support posts are tubular; and
the plurality of support posts have an upright projection and a dimension D2 transverse to the upright projection, the dimension D2 is smaller than the upright projection.

18. The acoustic detection node of claim 16, wherein the plurality of frame members have at least one of the following characteristics:
the plurality of frame members have a longitudinal projection L and a transverse dimension D1 that is transverse to the longitudinal projection L, the transverse dimension D1 is at most 10% of the longitudinal projection L;
the plurality of frame members are tubular;
the plurality of frame members extend at a similar relative angle in between them; and
the plurality of frame members extend in a straight manner from the central body.

19. An acoustic tracking system to at least detect intrusions within a detection zone, the system comprising:
a plurality of acoustic detection nodes as defined in claim 1; and
a monitoring module operatively connected to the plurality of acoustic detection nodes, the monitoring module receiving at least one of a signal indicative of a detection or location of intrusion within the detection zone and a signal indicative of an absence of intrusion from at least one of the plurality of acoustic detection nodes.

20. The acoustic tracking system of claim 19, further comprising at least one camera for visually validating the detected intrusions within the detection zone, the at least one camera is operatively connected to the monitoring module, wherein the monitoring module receives at least one of a signal indicative of a visual validation of the detection of intrusion and a signal indicative of an absence of visual validation from the at least one camera.
